(19) United States
(12) Patent Application Publication
(10) Pub. No.: US 2020/0169152 A1
(43) Pub. Date: May 28, 2020

(54) STATOR OF DYNAMO-ELECTRIC MACHINE

(71) Applicant: TOYOTA JIDOSHA KABUSHIKI KAISHA, Toyota-shi (JP)

(72) Inventors: Masashi MATSUMOTO, Nagoya-shi (JP); Hazuki KAWAMURA, Nisshin-shi (JP)

(73) Assignee: TOYOTA JIDOSHA KABUSHIKI KAISHA, Toyota-shi (JP)

(21) Appl. No.: 16/658,976

(22) Filed: Oct. 21, 2019

(30) Foreign Application Priority Data
Nov. 28, 2018 (JP) 2018-222060

(51) Int. Cl. H02K 15/085; H02K 3/48; H02K 3/12; H02K 15/06; H02K 1/14

(52) U.S. Cl. CPC H02K 15/085; H02K 3/48; H02K 1/148; H02K 15/064; H02K 3/12

(57) ABSTRACT

A stator of a dynamo-electric machine including: a stator core having a plurality of slots; and a stator coil wherein the stator coil includes: lower conductor segments inserted into the slots, a plurality of coupling members with fitting recesses formed therein such that inside the slots, tips of upper conductor segments are press-fitted into the fitting recesses to couple together the conductor segments, and a plurality of heat dissipation sheets placed between outer circumferential surfaces of the coupling members and inner surfaces of the slots.

### CROSS REFERENCE TO RELATED APPLICATION

This application claims priority to Japanese Patent Application No. 2018-222060 filed on Nov. 28, 2018, which is incorporated herein by reference in its entirety including the specification, claims, drawings, and abstract.

### TECHNICAL FIELD

The present disclosure relates to a structure of a dynamo-electric machine stator, and more particularly, to a structure of a stator provided with a stator coil formed by coupling together end portions of conductor segments in slots in a stator core.

### BACKGROUND

Generally, the stator of a dynamo-electric machine is formed by winding a stator coil around a stator core. A stator coil formed by coupling together multiple segment coils is known. In manufacturing such a stator coil, for example, substantially U-shaped conductor segments are inserted into slots in the stator core, and those portions of the conductor segments which protrude from an end face of the stator core in an axial direction are tilted down and thereby bent in a circumferential direction. Then, end portions of the bent conductor segments are joined to end portions of other similarly bent conductor segments by welding.

However, after the conductor segments are assembled onto the stator core, such a technique requires bending and welding of the conductor segments as well as insulation treatment of welded portions, complicating the manufacturing process.

Thus, it has been proposed to bend the conductor segments before assembling the conductor segments onto the stator core. JP 2009-194999 A proposes to prepare first conductor segments formed into a U-shape in advance and second conductor segments formed into a U-shape in advance, butt and join together tips of the first conductor segments and tips of the second conductor segments, thereby creating multi-phase circumferentially arranged coils of a distributed winding structure, and insert the circumferentially arranged coils in sequence into slots in the stator core to produce a stator.

### SUMMARY

The technique described in JP 2009-194999A adopts a joining method such as pressure welding or ultrasonic bonding to join together the tips of the first conductor segments and tips of the second conductor segments directly. However, these joining methods require large equipment, complicating the manufacturing process.

Thus, instead of directly joining together the tips of the first conductor segments and tips of the second conductor segments, a structure produced by inserting the first and second conductor segments into the slots and press-fitting the tips into coupling members and thereby coupling together the tips is under consideration.

In this structure, electric current flowing through the conductor segments flows through contacts between the conductor segments and coupling members. Consequently, due to contact resistance between the tips and coupling members, the coupling members may locally generate heat.

On the other hand, for insertion into the slots, outer sizes of the conductor segments and coupling members are set smaller than an inner size of the slots, so there are slight gaps between outer surfaces of the coupling members and inner surfaces of the slots. Consequently, there is a problem in that if the coupling members generate heat, difficulty is encountered in dissipating the heat to the stator core.

Thus, it is an advantage of the present disclosure to reduce heat generation of coupling members adapted to couple together end portions of conductor segments in a stator of a dynamo-electric machine.

A stator of a dynamo-electric machine according to the present disclosure comprises: a stator core having a plurality of slots; and a stator coil wound around the stator core, wherein the stator coil includes: a plurality of conductor segments inserted into the respective slots, a plurality of coupling members with fitting recesses formed therein such that inside the slots, respective end portions of the conductor segments are press-fitted into the fitting recesses to couple together the conductor segments, and a plurality of heat dissipation sheets placed, respectively, between outer circumferential surfaces of the coupling members and inner surfaces of the slots.

When the end portions of the conductor segments are press-fitted into the fitting recesses of the coupling members, as a result of diameter expansion of the coupling members, the outer surfaces of the coupling members and the inner surfaces of the slots are brought into close contact with each other via the heat dissipation sheets. Consequently, heat is dissipated from the coupling members to the stator core through the heat dissipation sheets, making it possible to reduce heat generation of the coupling members.

In the stator of a dynamo-electric machine according to the present disclosure, first ends of the coupling members may be attached to end portions of the conductor segments in a first group and inserted into the respective slots together with the end portions of the conductor segments in the first group, the fitting recesses may be formed in second ends, and inside the slots, end portions of the conductor segments in a second group may be press-fitted into the respective fitting recesses. Also, the heat dissipation sheets may be attached to outer circumferential surfaces of those portions of the respective coupling members in which the fitting recesses are formed.

This makes it possible to place the heat dissipation sheets between the outer circumferential surfaces of the coupling members and the inner surfaces of the slots in a simple and easy way.

In the stator of a dynamo-electric machine according to the present disclosure, the fitting recesses may be formed in both ends of the coupling members, and inside the slots, end portions of the conductor segments in a first group and end portions of the conductor segments in a second group may be press-fitted into the fitting recesses in both ends, respectively, coupling together the first group of the conductor segments and the second group of the conductor segments.

This increases expanded-diameter portions of the coupling members, thereby increasing regions in which the heat dissipation sheets are brought into close contact with inner surfaces of the stator core, and thus heat can be dissipated to the stator more effectively.

The present disclosure makes it possible to reduce heat generation of the coupling members adapted to couple together the end portions of the conductor segments in the stator of a dynamo-electric machine.

### BRIEF DESCRIPTION OF DRAWINGS

An embodiment of the present disclosure will be described based on the following figures, wherein:

FIG. 1 is a perspective view showing a step of inserting conductor segments into slots in a stator core;

FIG. 2 is a perspective view of an upper conductor segment;

FIG. 3 is a perspective view of a lower conductor segment with a coupling member attached to an end portion; and

FIG. 4 is a sectional view showing a step of press-fitting an end portion of the upper conductor segment into a fitting recess in a coupling member attached to an end portion of the lower conductor segment.

### DESCRIPTION OF EMBODIMENTS

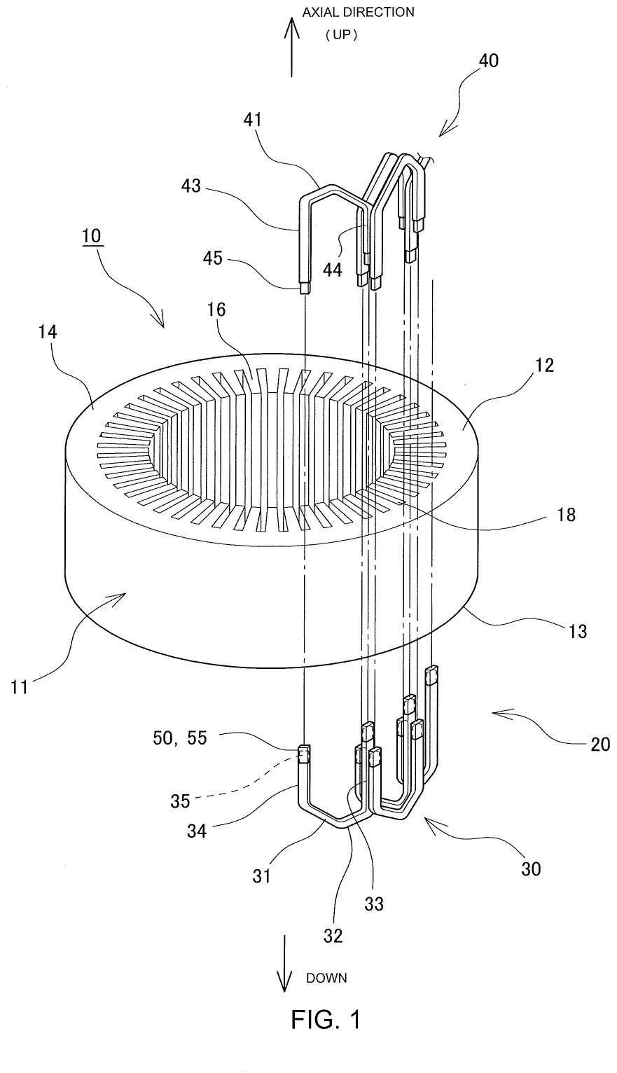

A stator 10 of a dynamo-electric machine according to an embodiment will be described below with reference to the drawings. As shown in FIG. 1, the stator 10 is made up of a stator core 11 and stator coil 20.

The stator core 11 is made up of a yoke 14, substantially annular in shape, and multiple teeth 16 protruding inward in a radial direction from an inner circumferential surface of the yoke 14. A slot 18, which is a space configured to house part of the stator coil 20, is formed between each pair of the teeth 16 placed next to each other in a circumferential direction. The stator core 11 may be, for example, a laminated steel plate created by laminating multiple flat rolled magnetic steel sheets (e.g., silicon steel sheets) in a thickness direction, or a dust core produced by press-forming magnetic particles covered with insulation coating.

The stator coil 20 is configured such that tips 45 of an upper conductor segment group 40 inserted into the slots 18 from the side of an upper end face 12 of the stator core 11 and tips 35 of a lower conductor segment group 30 inserted into the slots 18 from the side of a lower end face 13 of the stator core 11 will be coupled together in the slots 18 via coupling members 50 and wound around the teeth 16 of the stator core 11. A connection mode and winding mode of the stator coil 20 can be selected according to specifications of the dynamo-electric machine as appropriate and the stator coil 20 may be wound by distributed winding or concentrated winding.

As shown in FIG. 1, the upper conductor segment group 40 is made up of multiple upper conductor segments 41 each formed substantially in a U-shape.

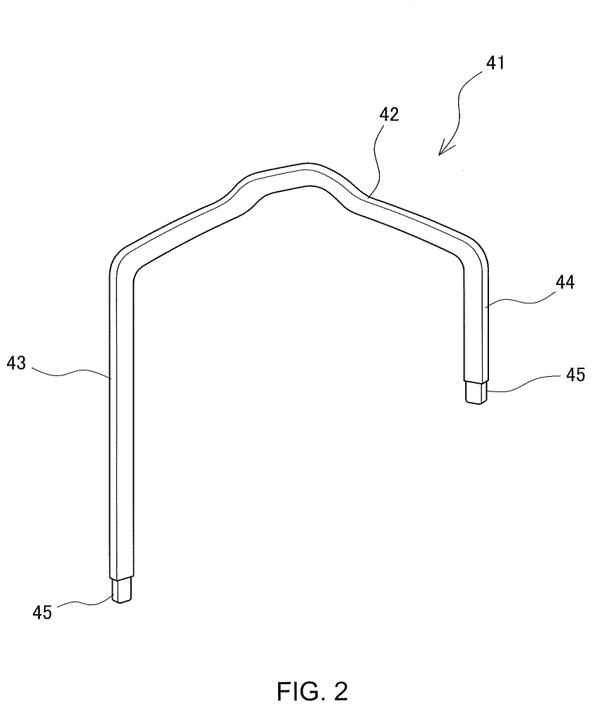

As shown in FIG. 2, each of the upper conductor segments 41 is formed by covering surfaces of a flat wire made of a conductive material such as copper with insulation coating and bent substantially into a U-shape. The upper conductor segment 41 is made up of a long leg 43, a short leg 44 shorter than the long leg 43 and parallel to the long leg 43, and a connecting portion 42 angle-shaped and configured to connect the legs 43 and 44. Outer dimensions of the long leg 43 and short leg 44 are set slightly smaller than an inner size of the slots 18 such that slight gaps will be created between the legs 43 and 44 and inner surfaces of the slots 18 when the legs 43 and 44 are inserted into the slots 18. Also, the tips 45 of end portions of the long leg 43 and short leg 44 are set smaller in the outer dimensions than other parts so as to be press-fitted into the coupling members 50 with the insulation coating removed.

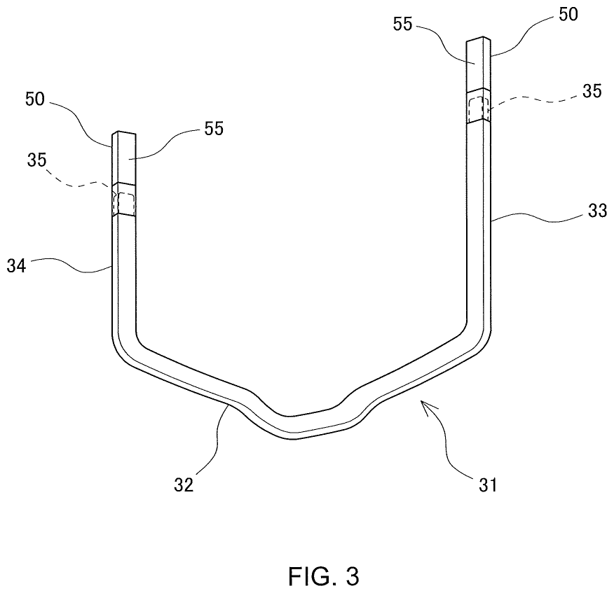

The lower conductor segment group 30 is made up of multiple lower conductor segments 31. As shown in FIG. 3, being bent substantially into a U-shape, each of the lower conductor segments 31 includes a long leg 33, a short leg 34, and a connecting portion 32, as with the upper conductor segment 41.

As with the upper conductor segment 41, outer dimensions of the long leg 33 and short leg 34 are set slightly smaller than the inner size of the slots 18. Also, the tips 35 of end portions of the long leg 33 and short leg 34 are set smaller in the outer dimensions than other parts with the insulation coating removed. The coupling members 50 are attached to the tips 35. A heat dissipation sheet 55 is attached to the outer circumferential surface of an upper half of each of the coupling members 50.

The long leg 43 and short leg 44 of the upper conductor segment 41 are inserted into the slots 18 from above and connected, via the coupling members 50, with the short leg 34 and long leg 33 of the lower conductor segment 31 that are inserted into the slots 18 from below. Also, the connecting portions 42 and 32 form coil ends by protruding from the upper end face 12 and lower end face 13 of the stator core 11, respectively. Therefore, total length of the long leg 33 and short leg 44 as well as total length of the long leg 43 and short leg 34 are substantially equal to the axial length of the slot 18. Also, the long legs 33 and 43 are longer in length than the short legs 34 and 44 by the length of the coupling member 50.

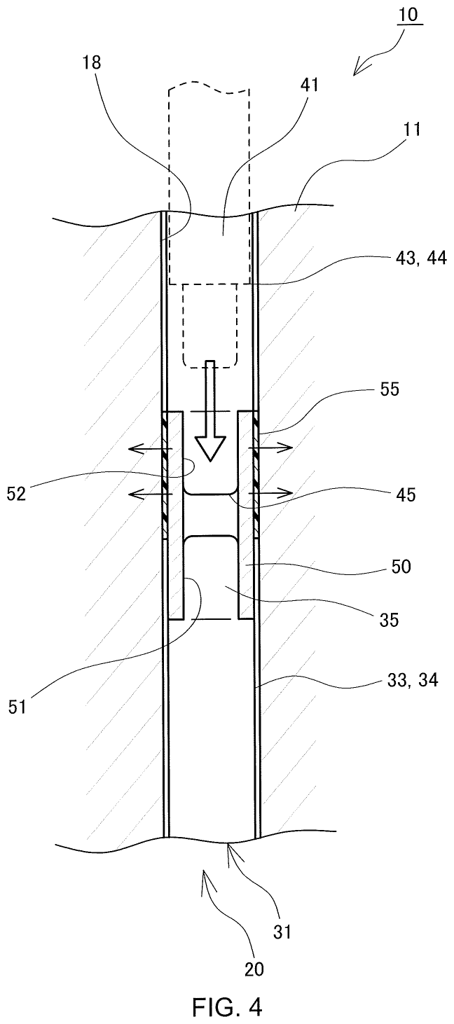

As shown in FIG. 4, the coupling member 50 is a square cylindrical member of a conductive material such as copper, a mounting recess 51 is formed in one end to mount the tip 35 of the lower conductor segment 31, and a fitting recess 52 is formed in another end to press-fit the tip 45 of the upper conductor segment 41. An inside diameter size of the fitting recess 52 is set slightly smaller than an outer dimension of the tip 45 of the upper conductor segment 41. Also, the heat dissipation sheet 55 is attached to the outer circumferential surface of the upper half in which the fitting recess 52 is formed. An outer size of an outer surface of the heat dissipation sheet 55 on the coupling member 50 is set slightly smaller than the inner size of the slot 18 to allow insertion into the slot 18 and is substantially equal to an outer dimension of the lower conductor segment 31. When the coupling member 50 is attached to the lower conductor segment 31 with the tip 35 of the lower conductor segment 31 inserted into the mounting recess 51, the outer surface of the heat dissipation sheet 55 on the coupling member 50 and outer surfaces of the legs 33 and 34 of the lower conductor segment 31 become substantially flush.

To assemble the stator coil 20, the lower conductor segments 31, which are conductor segments of a first group with the coupling members 50 attached to the tips 35, are inserted into the slots 18 from the side of the lower end face 13 of the stator core 11, where the lower conductor segments 31 are conductor segments of a first group. Since outer sizes of the legs 33 and 34 of the lower conductor segments 31 and outer surfaces of the heat dissipation sheets 55 on the coupling members 50 are slightly smaller than the inner size of the slots 18, when the lower conductor segments 31 are inserted in the slots 18, there are slight gaps between the outer circumferential surfaces of the legs 33 and 34 and heat dissipation sheets 55 and the inner surfaces of the slots 18.

Next, as indicated by the open arrow in FIG. 4, the upper conductor segments 41, which are conductor segments of a second group, are inserted from the side of the upper end face 12 of the stator core 11. Since the outer sizes of the legs 43 and 44 of the upper conductor segments 41 are slightly smaller than the inner size of the slots 18, there are slight gaps also between the outer circumferential surfaces of the legs 43 and 44 and the inner surfaces of the slots 18.

Next, the tips 45 of the upper conductor segments 41 are press-fitted into the fitting recesses 52 in the coupling members 50. The inside diameter size of the fitting recesses 52 is set slightly smaller than the outer dimension of the tips 45 of the upper conductor segments 41. Consequently, when the tips 45 are press-fitted into the fitting recesses 52, the fitting recesses 52 are expanded in diameter, increasing the outer dimension and bringing the heat dissipation sheets 55 mounted on the outer surfaces into close contact with the inner surfaces of the slots 18. Consequently, the outer surfaces the coupling members 50 are brought into close contact with the inner surfaces of the slots 18 via the heat dissipation sheets 55. Also, the upper conductor segments 41 and lower conductor segments 31 are electrically coupled together by the coupling members 50.

Since the outer surfaces of the coupling members 50 are in close contact with the inner surfaces of the slots 18 via the heat dissipation sheets 55 in this way, even if the coupling members 50 generate heat due to contact resistance between the coupling members 50 and upper conductor segments 41, the heat is dissipated to the stator core 11 via the heat dissipation sheets 55. This makes it possible to reduce heat generation of the coupling members 50. Also, since the coupling members 50 with the heat dissipation sheets 55 mounted on the outer surfaces are attached to the tips 35 of the lower conductor segments 31, by inserting the lower conductor segments 31 into the slots 18, the heat dissipation sheets 55 can be placed between the outer circumferential surfaces of the coupling members 50 and the inner surfaces of the slots 18 in a simple and easy manner.

Although in the embodiments described above, the lower conductor segments 31 are inserted into the slots 18 with the coupling members 50 attached to the tips 35 of the lower conductor segments 31, this is not restrictive, and the upper conductor segments 41 may be inserted into the slots 18 with the coupling members 50 attached to the tips 45 of the upper conductor segments 41, and then inside the slots 18, the tips 35 of the lower conductor segments 31 may be press-fitted into the fitting recesses 52.

Also, with the fitting recesses 52 formed in both ends of the coupling members 50 and with the heat dissipation sheets 55 mounted on the entire outer circumferential surfaces of the coupling members 50, by placing the coupling members 50 in predetermined positions of the slots 18 such as near the upper end face 12 or lower end face 13 of the stator core 11, the respective tips 45 and 35 of the upper conductor segments 41 and lower conductor segments 31 may be press-fitted into the respective fitting recesses 52 in the coupling members 50.

This will increase a diameter expansion range of the coupling members 50, as well as the area in which the coupling members 50 are placed in close contact with the inner surfaces of the slots 18 via the heat dissipation sheets 55, and thereby enable more effective dissipation to the stator core 11.

Also, with the heat dissipation sheets 55 placed on the inner surfaces of the slots 18, by inserting the lower conductor segments 31 into the slots 18 such that positions of the coupling members 50 mounted on the lower conductor segments 31 will coincide with positions of the heat dissipation sheets 55, the upper conductor segments 41 may be inserted into the slots 18, followed by press-fitting of the tips 45 into the fitting recesses 52.

1. A stator of a dynamo-electric machine comprising: a stator core having a plurality of slots; and a stator coil wound around the stator core, wherein the stator coil includes:
a plurality of conductor segments inserted into the respective slots,
a plurality of coupling members with fitting recesses formed therein such that inside the slots, respective end portions of the conductor segments are press-fitted into the fitting recesses to couple together the conductor segments, and
a plurality of heat dissipation sheets placed, respectively, between outer circumferential surfaces of the coupling members and inner surfaces of the slots.

2. The stator of a dynamo-electric machine according to claim 1, wherein first ends of the coupling members are attached to end portions of the conductor segments in a first group and inserted into the respective slots together with the end portions of the first group of the conductor segments, the fitting recesses are formed in second ends, and inside the slots, end portions of the conductor segments in a second group are press-fitted into the respective fitting recesses.

3. The stator of a dynamo-electric machine according to claim 2, wherein the heat dissipation sheets are attached to outer circumferential surfaces of those portions of the respective coupling members in which the fitting recesses are formed.

4. The stator of a dynamo-electric machine according to claim 1, wherein the fitting recesses are formed in both ends of the coupling members, and inside the slots, end portions of the conductor segments in a first group and end portions of the conductor segments in a second group are press-fitted into the fitting recesses in both ends, respectively, coupling together the first group of the conductor segments and the second group of the conductor segments.
